(19) United States
(12) Patent Application Publication
(10) Pub. No.: US 2025/0012320 A1
(43) Pub. Date: Jan. 9, 2025

(54) WEDGE BEARING FOR RECIPROCATING AND ROTATING APPLICATIONS

(71) Applicant: Freudenberg-NOK General Partnership, Plymouth, MI (US)

(72) Inventors: Michael MUELLER, Bowling Green, OH (US); Raymond L. SZPARAGOWSKI, Bowling Green, OH (US); Saikrishna SUNDARARAMAN, Canton, MI (US); Kristopher KINDLE, Ottawa, OH (US); Ross MAAG, Ottawa, OH (US)

(21) Appl. No.: 18/347,637

(22) Filed: Jul. 6, 2023

(51) Int. Cl. F16C 23/04

(52) U.S. Cl. CPC F16C 23/04; F16C 29/002; F16C 29/02; F16C 29/123; F16C 29/126

(57) ABSTRACT

A wedge bearing assembly includes a housing having a bore therein. A reciprocating rod having a polygonal cross-section extends through the bore. A ring is mounted to the housing and includes a plurality of sloped surfaces adjacent to a center polygonal opening. A plurality of wedges are disposed against a respective one of the plurality of sloped surfaces, each of the plurality of wedges having an edge disposed against the rod. A washer is disposed against the plurality of wedges and an annular spring is disposed against the washer. A tension ring is disposed against the annular spring.

### FIELD

The present disclosure relates to a wedge bearing for reciprocating and rotating applications.

### BACKGROUND

This section provides background information related to the present disclosure which is not necessarily prior art.

Bearing assemblies have been commonly used for supporting rotating and reciprocating shafts and rods. In some applications, a reciprocating rod is exposed to torsion forces and temperature variations that can tend to bind the reciprocating rod.

### SUMMARY

This section provides a general summary of the disclosure, and is not a comprehensive disclosure of its full scope or all of its features.

According to an aspect of the present disclosure, a wedge bearing assembly includes a housing having a bore therein. A reciprocating rod having a polygonal cross-section extends through the bore. A ring is mounted to the housing and includes a plurality of sloped surfaces adjacent to a center polygonal opening. A plurality of wedges are disposed against a respective one of the plurality of sloped surfaces, each of the plurality of wedges having an edge disposed against the rod. A washer is disposed against the plurality of wedges and an annular spring is disposed against the washer. A tension ring is disposed against the annular spring.

According to a further aspect, a seal member is disposed between the tension ring and the reciprocating rod.

According to a further aspect, the annular spring is one of a wave spring, a Belleville washer, an elastomeric energizer or other spring.

According to a further aspect, the polygonal cross-section is a square.

According to a further aspect, the plurality of sloped surfaces include four sloped surfaces and the plurality of wedges include four wedges.

According to a further aspect, the tension ring is threadedly connected to the wedge ring.

According to a further aspect, the seal member is retained within a cavity of the tension ring by a snap ring.

According to a further aspect, the seal member includes a pair of diagonal seal lips.

According to a further aspect, the seal member includes a seal housing that supports the pair of diagonal seal lips.

According to another aspect of the present disclosure, a wedge bearing assembly includes a housing having a bore therein and a reciprocating rod having a square cross-section and extending through the bore. A ring is mounted to the housing and includes four sloped surfaces adjacent to a square opening. Four wedges are each disposed against a respective one of the four sloped surfaces. Each of the four wedges have an edge disposed against the rod. A washer is disposed against the four wedges and an annular spring is disposed against the washer. A tension ring is disposed against the annular spring. The wedges can be connected together so as to be one piece by including thin connectors between the four wedges as a ring. The four sloped surfaces can be formed by an additional four wedges.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of a wedge bearing cartridge according to the principles of the present disclosure;

FIG. 2 is an exploded perspective view of the wedge bearing cartridge according to the principles of the present disclosure;

FIG. 3 is a perspective view of the wedge bearing cartridge;

FIG. 4 is a perspective view of the wedge ring, wedges, washer and spring prior to assembly to the housing according to the principles of the present disclosure;

FIG. 5 is a cross-sectional view of a second embodiment of a wedge bearing cartridge according to the principles of the present disclosure;

FIG. 6 is a cut-away perspective view of the second embodiment of the wedge bearing cartridge according to the principles of the present disclosure with the seal member removed for illustrative purposes;

FIG. 7 is a cross-sectional view of a wedge bearing cartridge according to an alternative embodiment;

FIG. 8 is an exploded perspective view of a wedge bearing cartridge according to the principles of the present disclosure with a seal housing and assembly aid;

FIG. 9 is a perspective view of the wedge bearing cartridge of FIG. 8 shown partially assembled;

FIG. 10 is a cross sectional perspective view of the partially assembled wedge bearing cartridge of FIG. 9; and

FIG. 11 is a perspective view of the assembled wedge bearing cartridge of FIG. 8.

Corresponding reference numerals indicate corresponding parts throughout the several views of the drawings.

### DETAILED DESCRIPTION

Example embodiments will now be described more fully with reference to the accompanying drawings.

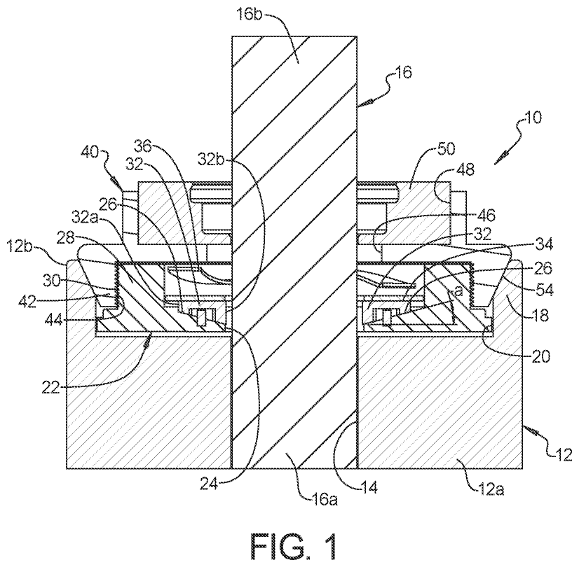

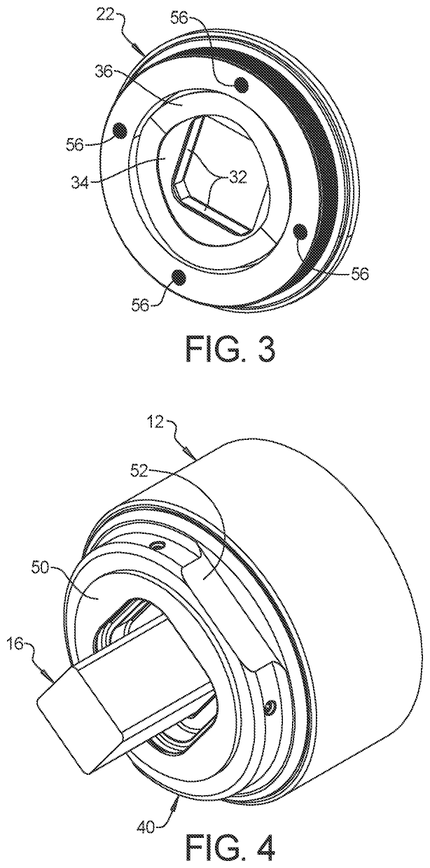

With reference to FIGS. 1-4, a wedge bearing cartridge assembly 10 according to the principles of the present disclosure will now be described. The wedge bearing cartridge assembly 10 include a housing 12 having a square or polygonal bore 14 extending therethrough. A reciprocating rod 16 having a square or polygonal cross-section extends through the square or polygonal bore 14. The present disclosure and drawings show a square rod and square bore, although other polygonal shapes such as triangular, rectangular, pentagon, can also be used. The square or polygonal cross-section of the reciprocating rod 16 and the square or polygonal bore 14 can include rounded corners. One axial end 12a of the housing 12 can be configured to be connected to another component such as, but not limited to, a robotic arm. A second axial end 12b of the housing 12 can include an annular rim 18 defining a cavity 20. The reciprocating rod 16 can have a first end 16a configured to be connected to a drive member and a second end 16b configured to be connected to a driven member.

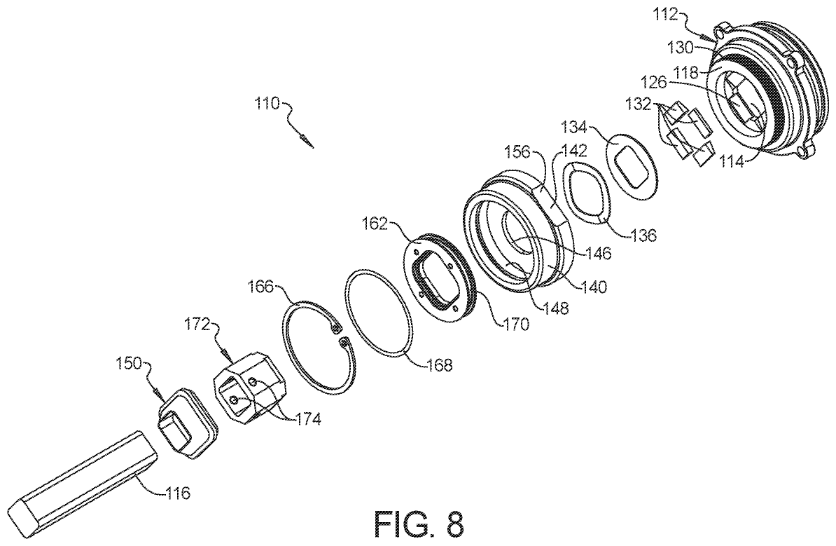

A wedge ring 22 is received in the cavity 20 of the housing 12. The wedge ring 22 can be press fit within the cavity 20. The wedge ring 22 includes a square bore 24 therethrough for receiving the reciprocating rod 16. The wedge ring 22 further includes four sloped surfaces 26 that are each adjacent to a respective side of the square bore 24 The four sloped surfaces 26 can be angled at an angle “a” of between 10 and 35 degrees from perpendicular to a center axis of the reciprocating rod 16. More particularly, the four sloped surfaces 26 can be angled at an angle “a” of about 15 degrees from perpendicular to the center axis of the reciprocating rod 16. The wedge ring 22 can further include an axially extending flange 28 having an externally threaded surface 30. The four sloped surfaces 26 can be integrally formed with the wedge ring 22 or, as shown in FIG. 8, can be formed as four separate wedges 26′.

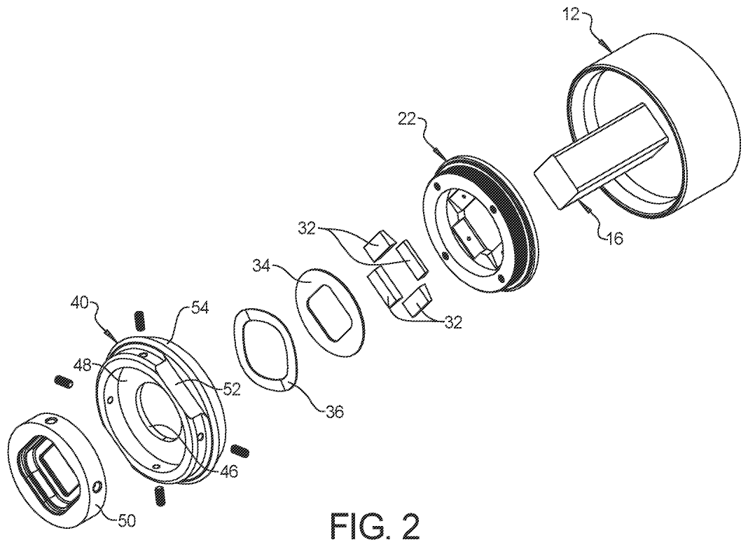

As best shown in FIG. 2, four wedges 32 are disposed against the four sloped surfaces 26 of the wedge ring 22. The four wedges 32 have a triangular cross-section with a narrow outer edge 32a and a relatively wider inner edge 32b that extend along the edges of the square bore 24 and engage a respective side of the reciprocating rod 16. A washer 34 is disposed against the four wedges 32. A spring 36 is disposed against the washer 34 for biasing the four wedges 32 against the sloped surfaces 26. The spring 36 can include a wave spring as shown or can take on alternative forms such as a Belleville washer, an elastomeric energizer, a coil spring or other spring.

A tension ring 40 is disposed against the spring 36. The tension ring 40 can include an annular flange 42 having an internally threaded surface 44 that threadedly engages the externally threaded surface 30 of the wedge ring 22. The tension ring 40 has an aperture 46 therethrough that defines an annular cavity 48 that supports a seal member 50 that slidingly engages the reciprocating rod 16. The tension ring 40 can include flats 52 to facilitate turning of the tension ring relative to the wedge ring 22 to adjust the spring force against the wedges 32. The sloped surfaces 26 along with the spring 36 allow the wedges 32 to be biased radially inward against the reciprocating rod 16 to provide bearing surfaces for guiding the reciprocating rod 16 through the wedge bearing cartridge assembly 10. The tension ring 40 can include a tapered exterior surface 54 that provides an axial stop surface against the annular rim 18 of the housing 12.

The wedge bearing cartridge assembly 10 can be assembled as a unit prior to being installed in the housing 12. The wedge ring 22 can be provided with holes 56 for holding the wedge ring 22 during assembly with the tension ring 40 prior to press fit assembly into the housing 12.

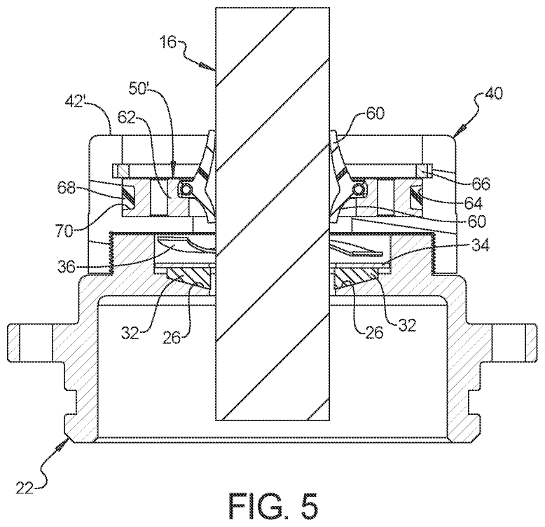

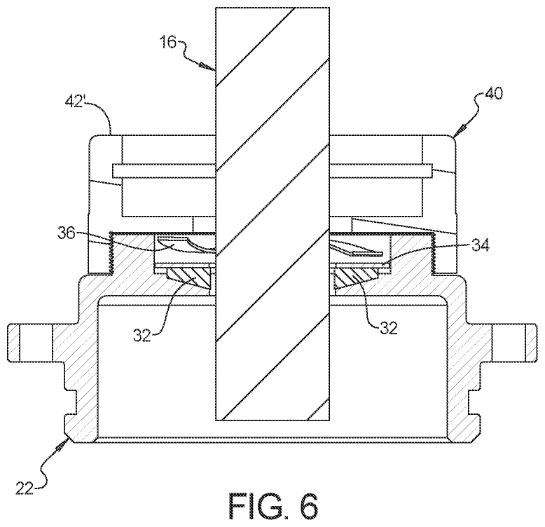

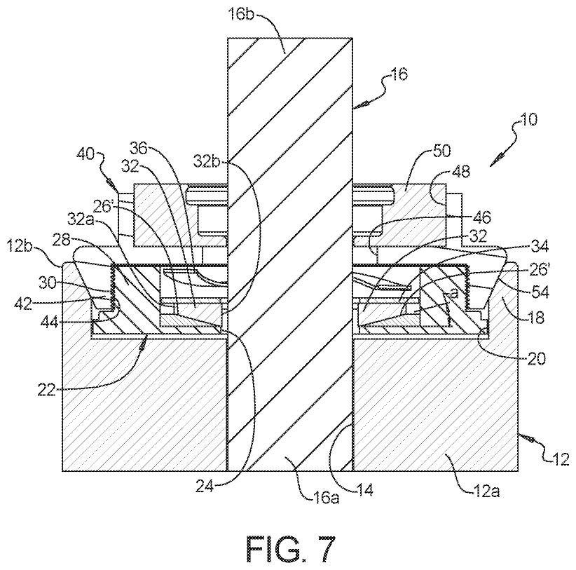

The seal member 50 can take on alternative forms. The seal member can include a pair of seal lips 60 that engage the reciprocating rod 16. With reference to the embodiment of FIGS. 5-6, the seal member 50′ can include a seal housing 62 that is retained within a cavity 64 of the tension ring 40′ by a snap ring 66. An O-ring 68 can be received in a recessed annular groove 70 in an exterior surface of the seal housing and engage an interior surface of the annular flange 42′. The seal member 50′ further includes the pair of seal lips 60 secured to the seal housing 62. The pair of seal lips 60 are diagonal seal lips that slide along a surface of the reciprocating rod 16.

The wedge bearing cartridge assembly 10 is capable of performing its bearing function while providing an improved performance in accommodating for temperature variations and rotational forces as compared to solid annular bearings.

With reference to FIGS. 8-11, a wedge bearing cartridge assembly 110 according to an alternative embodiment will now be described. As shown in FIG. 11, the wedge bearing cartridge assembly 110 includes a housing 112 having a square or polygonal bore 114 extending therethrough. A reciprocating rod 116 having a square or polygonal cross-section extends through the square or polygonal bore 114. The present disclosure and drawings show a square rod and square bore, although other polygonal shapes such as triangular, rectangular, pentagon, can also be used. The square or polygonal cross-section of the reciprocating rod 116 and the square or polygonal bore 114 can include rounded corners. One axial end 112a of the housing 112 can be configured to be connected to another component such as, but not limited to, a robotic arm. A second axial end 112b of the housing 112 can include an annular rim 118 defining a cavity 120. The reciprocating rod 116 can have a first end 116a configured to be connected to a drive member and a second end 116b configured to be connected to a driven member.

The cavity 120 includes four sloped surfaces 126 that are each adjacent to a respective side of the square bore 114. The four sloped surfaces 126 can be angled at an angle “a” of between 10 and 35 degrees from perpendicular to a center axis of the reciprocating rod 116. More particularly, the four sloped surfaces 126 can be angled at an angle “a” of about 15 degrees from perpendicular to the center axis of the reciprocating rod 116. The annular rim 118 of the housing 112 can further include an externally threaded surface 130. The four sloped surfaces 126 can be integrally formed with the housing 112 or, can be formed as four separate wedges.

As best shown in FIG. 8, four wedges 132 are disposed against the four sloped surfaces 126 of the housing 112. The four wedges 132 have a triangular cross-section with a narrow outer edge and a relatively wider inner edge that extend along the edges of the square bore 124 and engage a respective side of the reciprocating rod 116. A washer 134 is disposed against the four wedges 132. A spring 136 can be disposed against the washer 134 for biasing the four wedges 132 against the sloped surfaces 126. The spring 136 can include a wave spring as shown or can take on alternative forms such as a Belleville washer, an elastomeric energizer, a coil spring or other spring.

A tension ring 140 is disposed against the spring 136. The tension ring 140 can include an annular flange 142 having an internally threaded surface 144 that threadedly engages the externally threaded surface 130 of the housing 112. The tension ring 140 has an aperture 146 therethrough that defines an annular cavity 148 that supports a seal member 150 that slidingly engages the reciprocating rod 116. An exterior surface of the tension ring 140 can include flats 152 to facilitate turning of the tension ring relative to the housing 112 to adjust the spring force against the wedges 132. The sloped surfaces 126 along with the spring 136 allow the wedges 132 to be biased radially inward against the reciprocating rod 116 to provide bearing surfaces for guiding the reciprocating rod 116 through the wedge bearing cartridge assembly 110.

The seal member 150 can take on alternative forms. The seal member 150 can include a pair of seal lips 160 that engage the reciprocating rod 116. The seal member 150 can include a seal housing 162 that is retained within a cavity 164 of the tension ring 140 by a snap ring 166. An O-ring 168 can be received in a recessed annular groove 170 in an exterior surface of the seal housing and engage an interior surface of the annular flange 142. The seal member 150 further includes the pair of seal lips 160 secured to the seal housing 162. The pair of seal lips 160 are diagonal seal lips that slide along a surface of the reciprocating rod 116.

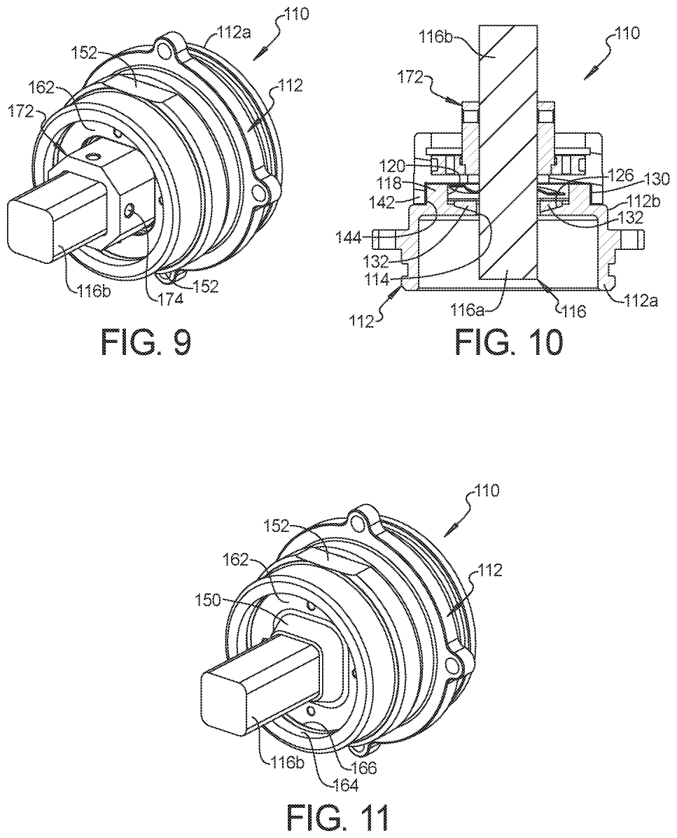

With reference to FIGS. 9 and 10, an assembly aid 172 can be mounted to the reciprocating rod 116 for centering the reciprocating rod 116 relative to the seal housing 162 during alignment of the wedges 132. The assembly aid 172 can be attached by set screws 174 and has a shape that matches a shape of an interior of the seal housing 162. The assembly aid 172 is removed from the reciprocating rod 116 after the wedge bearing cartridge assembly 110 is assembled. The seal member 150 is then engaged with the seal housing 162.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A wedge bearing assembly, comprising:
a housing having a bore therein;
a reciprocating rod extending through the bore, the rod having a polygonal cross-section;
a ring mounted to the housing and including a plurality of sloped surfaces adjacent to a center polygonal opening;
a plurality of wedges each disposed against a respective one of the plurality of sloped surfaces, each of the plurality of wedges having an edge disposed against the rod;
a spring loaded washer disposed against the plurality of wedges; and
a tension ring disposed against the spring loaded washer.

2. The wedge bearing assembly according to claim 1, further comprising a seal member disposed between the tension ring and the reciprocating rod.

3. The wedge bearing assembly according to claim 1, wherein the spring loaded washer includes one of a wave spring, a Belleville washer, a coil spring and a rubber elastomer.

4. The wedge bearing assembly according to claim 1, wherein the polygonal cross-section is a square.

5. The wedge bearing assembly according to claim 4, wherein the plurality of sloped surfaces includes four sloped surfaces and the plurality of wedges includes four wedges.

6. The wedge bearing assembly according to claim 5, wherein the plurality of sloped surfaces are formed by a first set of four wedges and the plurality of wedges include a second set of four wedges.

7. The wedge bearing assembly according to claim 1, where the tension ring is threadedly connected to the wedge ring.

8. The wedge bearing assembly according to claim 2, wherein the seal member is retained within a cavity of the tension ring by a snap ring.

9. The wedge bearing assembly according to claim 8, wherein the seal member includes a pair of diagonal seal lips.

10. The wedge bearing assembly according to claim 9, wherein the seal member includes a seal housing that supports the pair of diagonal seal lips.

11. The wedge bearing assembly according to claim 1, wherein the plurality of wedges are made from one of bronze, steel, PTFE, plastic and PEEK.

12. A wedge bearing assembly, comprising:
a housing having a bore therein;
a reciprocating rod extending through the bore, the rod having a square cross-section;
a ring mounted to the housing and including a four sloped surfaces adjacent to a square opening;
four wedges each disposed against a respective one of the four sloped surfaces, each of the four wedges having an edge disposed against the rod;
a spring loaded washer disposed against the four wedges; and
a tension ring disposed against the spring loaded washer.

13. The wedge bearing assembly according to claim 12, further comprising a seal member disposed between the tension ring and the reciprocating rod.

14. The wedge bearing assembly according to claim 12, wherein the spring loaded washer includes one of a wave spring, a Belleville washer, a coil spring and a rubber elastomer.

15. The wedge bearing assembly according to claim 12, where the tension ring is threadedly connected to the wedge ring.

16. The wedge bearing assembly according to claim 13, wherein the seal member is retained within a cavity of the tension ring by a snap ring.

17. The wedge bearing assembly according to claim 16, wherein the seal member includes a pair of diagonal seal lips.

18. The wedge bearing assembly according to claim 17, wherein the seal member includes a seal housing that supports the pair of diagonal seal lips.

19. The wedge bearing assembly according to claim 12, wherein the plurality of wedges are made from one of bronze, steel, PTFE, plastic and PEEK.

20. The wedge bearing assembly according to claim 12, wherein the four wedges includes a first set of four wedges and the four sloped surfaces are formed by a second set of four wedges.
